(19) United States
(12) Patent Application Publication
(10) Pub. No.: US 2015/0097925 A1
(43) Pub. Date: Apr. 9, 2015

(54) APPARATUS AND METHOD FOR DISPLAYING HOLOGRAM BASED ON PUPIL TRACKING USING HYBRID CAMERA

(71) Applicant: Electronics and Telecommunications Research Institute, Daejeon (KR)

(72) Inventors: Hyon Gon CHOO, Daejeon (KR); Min Sik PARK, Sejong (KR); Hyun Eui KIM, Cheongju-si (KR); Kyung Ae MOON, Daejeon (KR); Jin Woong KIM, Daejeon (KR)

(21) Appl. No.: 14/503,645

(22) Filed: Oct. 1, 2014

(30) Foreign Application Priority Data
Oct. 4, 2013 (KR) 10-2013-0118514
Apr. 4, 2014 (KR) 10-2014-0040787

(51) Int. Cl. G06K 9/00; G02B 27/00; G03H 1/26; G06T 7/00; G03H 1/00

(52) U.S. Cl. CPC G06K 9/00604; G06T 7/002; G03H 1/0005; G03H 1/268; G02B 27/0093; G03H 2001/0088; G06T 2207/10024; G06T 2207/10028; G06T 2207/30196
USPC 348/40; 382/103

(57) ABSTRACT

Provided are an apparatus and a method for displaying a hologram based on pupil tracking using a hybrid camera, wherein a hologram display apparatus includes a pupil tracker to track a location of a pupil of a user using a depth image and a color image generated by capturing an image of the user, a viewing window controller to control a viewing window of a hologram based on the tracked location of the pupil of the user, and a hologram generator to generate a hologram based on the controlled viewing window.

### CROSS-REFERENCE TO RELATED APPLICATION

This application claims the priority benefit of Korean Patent Application No. 10-2013-0118514, filed on Oct. 4, 2013, and No. 10-2014-0040787, filed on Apr. 4, 2014, in the Korean Intellectual Property Office, the disclosures of which are incorporated herein by reference.

### BACKGROUND

1. Field of the Invention

The present invention relates to an apparatus and a method for displaying a hologram based on pupil tracking using a hybrid camera, and more particularly, to an apparatus and a method for tracking a pupil of a user using a depth image and a color image and displaying a hologram optimized for a result of the pupil tracking.

2. Description of the Related Art

Digital holographic display technology may output a stereoscopic image to a three-dimensional (3D) space based on a light diffraction phenomenon, for example, a laser, using a special light modulator (SLM). However, in the digital holographic display technology, an area in which a hologram is observed may be excessively limited due to size restrictions of a pixel of the SLM and thus, only a small-sized image may be viewed. Thus, sub-hologram display technology has been developed to allow a user to experience a larger image in a broader range by implementing a limited viewing window of a digital holographic display to be a size of a pupil of the user. Here, the sub-hologram display technology may display a hologram based on a location of the pupil of the user and thus, a method of tracking the location of the pupil of the user may be required.

Among conventional pupil tracking methods, a method using a depth camera may be applied to search for an exact location of a face of a user using 3D information on a depth image. However, the depth image may have a lower resolution than a color image and thus, an error in detecting a location of an eye of the user may occur. Also, detecting a pupil smaller than the eye may be challenging.

Also, another method using a stereo camera may accurately detect a pupil by applying a stereo camera with a high resolution. However, an amount of calculation may increase to detect an eye in an entire high-resolution image and thus, an error may frequently occur due to a difference between a left image captured by a left camera and a right image captured by a right camera.

Accordingly, there is a desire for a method of tracking a location of a pupil with a reduced amount of calculation and without an error.

### SUMMARY

An aspect of the present invention provides an apparatus and a method for minimizing an error in a pupil detecting process and increasing a calculation speed by tracking a pupil of a user using a color image captured by a stereo camera and a depth image captured by a depth camera.

According to an aspect of the present invention, there is provided a hologram display apparatus including a pupil tracker to track a location of a pupil of a user using a depth image and a color image generated by capturing an image of the user, a viewing window controller to control a viewing window of a hologram based on the tracked location of the pupil of the user, and a hologram generator to generate a hologram based on the controlled viewing window.

The pupil tracker may include an eye location determiner to determine a location of an eye of the user in the depth image, an eye location estimator to estimate a location of the eye in the color image based on the determined location of the eye, and a pupil location determiner to determine the location of the pupil in the color image based on the estimated location of the eye.

The pupil tracker may include a first eye location determiner to determine a location of an eye of the user in the depth image, an eye location estimator to estimate a location of the eye in the color image based on the determined location of the eye, a second eye location determiner to determine a location of the eye in the color image, and a pupil location determiner to determine the location of the pupil in the color image based on the estimated location of the eye in the color image and the determined location of the eye in the color image.

The pupil location determiner may determine a validity of the estimated location of the eye in the color image and the determined location of the eye in the color image, set an eye region based on a result of the determining, and determine the location of the pupil by searching for the pupil in the eye region.

The pupil location determiner may compare the estimated location of the eye in the color image and the determined location of the eye in the color image to a location of the pupil determined in a previous frame, set an eye region based on a result of the comparing, and determine the location of the pupil by searching for the pupil in the eye region.

The hologram display apparatus may further include a camera calibration unit to perform calibration between a stereo camera capturing the color image and a depth camera capturing the depth image.

The camera calibration unit may calculate mapping information used to map three-dimensional (3D) coordinates of the depth image to two-dimensional (2D) coordinates of the color image based on an equation representing a projection relationship between the 3D coordinates and the 2D coordinates.

According to another aspect of the present invention, there is provided a pupil tracking apparatus including an eye location determiner to determine a location of an eye of a user in a depth image, an eye location estimator to estimate a location of the eye in a color image based on the determined location of the eye, and a pupil location determiner to determine a location of a pupil in the color image based on the estimated location of the eye.

According to still another aspect of the present invention, there is provided a pupil tracking apparatus including a first eye location determiner to determine a location of an eye of a user in a depth image, an eye estimator to estimate a location of the eye in a color image based on the determined location of the eye, a second eye location determiner to determine a location of the eye in the color image, and a pupil location determiner to determine a location of a pupil in the color image based on the estimated location of the eye in the color image and the determined location of the eye in the color image.

When one of the estimated location of the eye in the color image and the determined location of the eye in the color image is valid, the pupil location determiner of the pupil tracking apparatus may set the valid location to be an eye region.

When both of the estimated location of the eye in the color image and the determined location of the eye in the color image are valid, the pupil location determiner of the pupil tracking apparatus may set the eye region by combining the estimated location of the eye in the color image and the determined location of the eye in the color image.

According to a yet another aspect of the present invention, there is provided a hologram displaying method including tracking a location of a pupil of a user using a depth image and a color image generated by capturing an image of the user, controlling a viewing window of a hologram based on the tracked location of the pupil of the user, and generating a hologram based on the controlled viewing window.

According to a further another aspect of the present invention, there is provided a pupil tracking method including determining a location of an eye of a user in a depth image, estimating a location of the eye in a color image based on the determined location of the eye, and determining a location of a pupil in the color image based on the estimated location of the eye.

According to a still another aspect of the present invention, there is provided a pupil tracking method including determining a location of an eye of a user in a depth image, estimating a location of the eye in a color image based on the determined location of the eye, determining a location of the eye in the color image, and determining a location of a pupil in the color image based on the estimated location of the eye in the color image and the determined location of the eye in the color image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a hologram display apparatus according to an embodiment of the present invention;

FIG. 2 is a diagram illustrating an example of an operation of a hologram display apparatus according to an embodiment of the present invention;

FIG. 3 is a diagram illustrating a pupil tracker according to an embodiment of the present invention;

FIG. 4 is a diagram illustrating a pupil tracker according to another embodiment of the present invention;

FIG. 5 is a diagram illustrating an operation of a pupil tracker according to another embodiment of the present invention;

FIG. 6 is a flowchart illustrating a hologram displaying method according to an embodiment of the present invention;

FIG. 7 is a flowchart illustrating a pupil tracking method according to an embodiment of the present invention; and

FIG. 8 is a flowchart illustrating a pupil tracking method according to another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the accompanying drawings, however, the present invention is not limited thereto or restricted thereby.

When it is determined a detailed description related to a related known function or configuration that may make the purpose of the present invention unnecessarily ambiguous in describing the present invention, the detailed description will be omitted here. Also, terms used herein are defined to appropriately describe the exemplary embodiments of the present invention and thus, may be changed depending on a user, the intent of an operator, or a custom. Accordingly, the terms must be defined based on the following overall description of this specification.

A hologram displaying method described herein may be performed by a hologram display apparatus described herein.

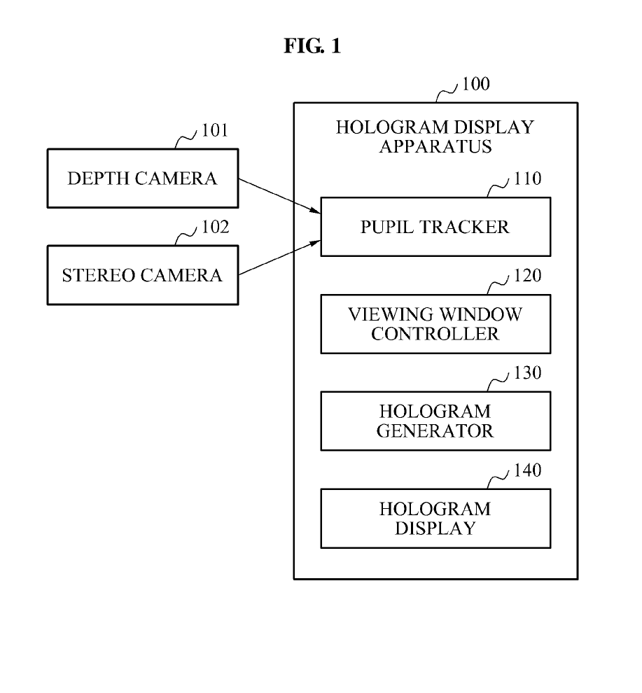

FIG. 1 is a diagram illustrating a hologram display apparatus 100 according to an embodiment of the present invention.

Referring to FIG. 1, the hologram display apparatus 100 includes a pupil tracker 110, a viewing window controller 120, a hologram generator 130, and a hologram display 140.

The pupil tracker 110 may track a location of a pupil of a user using a depth image generated by capturing an image of the user by a depth camera 101 and a color image generated by capturing an image of the user by a stereo camera 102. The depth camera 101 and the stereo camera 102 may have different resolutions and characteristics. The depth camera 101 and the stereo camera 102 may be separately configured cameras, or included in a hybrid camera.

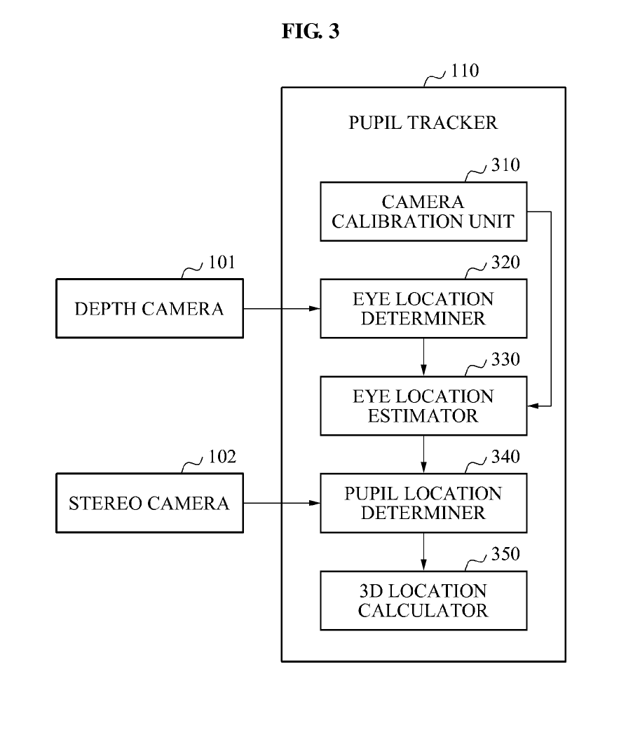

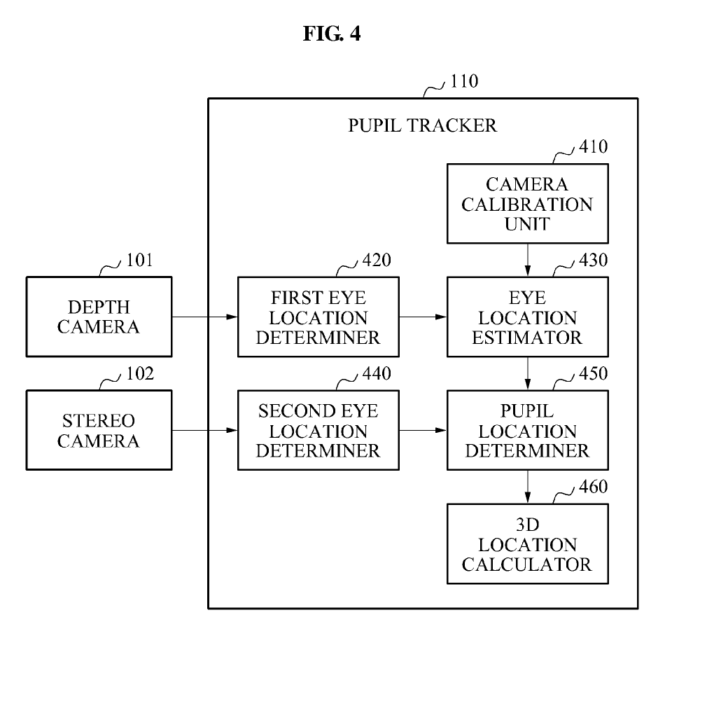

A detailed configuration and operation of the pupil tracker 110 will be further described with reference to FIGS. 3 and 4.

The viewing window controller 120 may control a viewing window of a hologram based on the location of the pupil of the user tracked by the pupil tracker 110. The viewing window controller 120 may control the viewing window of the hologram by controlling a position of a light source and a position of a special light modulator (SLM) to output the hologram.

The hologram generator 130 may generate a hologram optimized for a visual field of the user based on the viewing window controlled by the viewing window controller 120.

The hologram display 140 may output the hologram generated by the hologram generator 130 to a space and display the hologram.

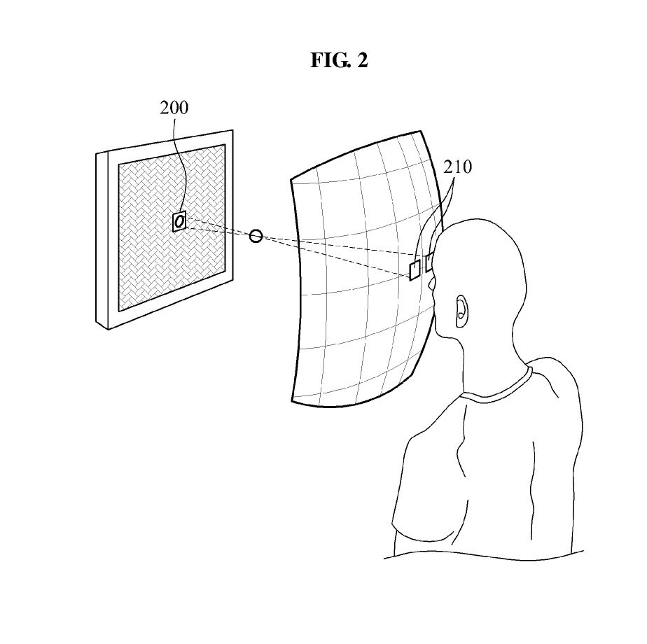

FIG. 2 is a diagram illustrating an example of an operation of the hologram display apparatus 100 according to an embodiment of the present invention.

Referring to FIG. 2, the hologram display apparatus 100 may track a pupil of a user, and display a hologram 200 by optimizing a viewing window of a digital holographic display for a location 210 of the pupil of the user. The user may view the hologram 200 optimized for the location 210 of the pupil and thus, may experience a larger image in a broader range.

FIG. 3 is a diagram illustrating the pupil tracker 110 according to an embodiment of the present invention.

Referring to FIG. 3, the pupil tracker 110 includes a camera calibration unit 310, an eye location determiner 320, an eye location estimator 330, a pupil location determiner 340, and a three-dimensional (3D) location calculator 350.

The camera calibration unit 310 may perform stereo calibration to correct a distance between a left camera and a right camera of the stereo camera 102 using a general stereo calibration method. More particularly, the camera calibration unit 310 may extract a camera parameter based on coordinates of a feature point between a left image and a right image. Based on the extracted camera parameter, the camera calibration unit 310 may calculate 3D location coordinates based on a disparity between the left image captured by the left camera and the right image captured by the right camera.

Also, the camera calibration unit 310 may perform the calibration between the depth camera 101 and the stereo camera 102. More particularly, the camera calibration unit 310 may calculate a projection matrix, which is mapping information, used to estimate image coordinates of the color image captured by the stereo camera 102 corresponding to 3D coordinates of the depth image captured by the depth camera 101.

For example, a projection relationship between 3D coordinates of a depth image, “X={Xw, Yw, Zw},” and 2D coordinates of a color image, “x=(x,y),” may be represented by Equation 1.

$$x = PX \\ [ \begin{matrix}x \\ y \\ 1\end{matrix} ] = [ \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34}\end{matrix} ] [ \begin{matrix}{X}_{w} \\ {Y}_{w} \\ {Z}_{w} \\ 1\end{matrix} ] \qquad [ Equation 1 ]$$

When a 2D coordinate corresponding to an ith 3D coordinate “Xi” is defined as “xi,” Equation 1 may be expressed as Equation 2.

$${x}_{i} = {PX}_{i} \\ {x}_{i} = \frac{{p}_{11} {X}_{i} + {p}_{12} {Y}_{i} + {P}_{13} {Z}_{i} + {P}_{14}}{{p}_{31} {X}_{i} + {p}_{32} {Y}_{i} + {P}_{33} {Z}_{i} + {P}_{34}} \\ {y}_{i} = \frac{{p}_{21} {X}_{i} + {p}_{22} {Y}_{i} + {P}_{23} {Z}_{i} + {P}_{24}}{{p}_{31} {X}_{i} + {p}_{32} {Y}_{i} + {P}_{33} {Z}_{i} + {P}_{34}} \qquad [ Equation 2 ]$$

In Equation 2, a process of calculating “P” may be defined as Equation 3.

$${min}_{P} {\sum }_{i}^{ } {( ( {x}_{i} , {y}_{i} ) - P ( {X}_{i} , {Y}_{i} , {Z}_{i} ) )}^{2} \qquad [ Equation 3 ]$$

In Equation 3, the camera calibration unit 310 may obtain the 2D coordinates of the color image from the 3D coordinates (X, Y, Z) of the depth image using the P obtained by Equation 3. The camera calibration unit 310 may calculate the projection matrix corresponding to each of the left camera and the right camera of the stereo camera 102.

The eye location determiner 320 may determine a location of an eye of the user in the depth image captured by the depth image 101. The eye location determiner 320 may determine the location of the eye of the user in the depth image using a general face and eye recognition algorithm, and extract coordinates of the determined location of the eye. For example, the eye location determiner 320 may estimate a face of the user using a Haar feature based face recognition or Local Binary Pattern (LBP) based face recognition or an active appearance model (AAM) method.

The eye location estimator 330 may estimate a location of the eye in the color image based on the location of the eye determined by the eye location determiner 320. The eye location estimator 330 may estimate the location of the eye corresponding to a location of the eye determined by the eye location determiner 320 in the color image using the mapping information calculated by the camera calibration unit 310. For example, the eye location estimator 330 may be a mapping module to extract coordinates of the eye in the color image captured by the stereo camera 102 using the mapping information and coordinates of the eye extracted from the depth image.

The pupil location determiner 340 may determine a location of a pupil of the user included in the color image generated by the stereo camera 102 based on the location of the eye estimated by the eye location estimator 330. The pupil location determiner 340 may set the location of the eye estimated by the eye location estimator 330 to be an eye region, and determine the location of the pupil by searching for the location of the pupil in the eye region.

The 3D location calculator 350 may calculate 3D pupil location coordinates based on a location of a left pupil and a location of a right pupil determined by the pupil location determiner 340. The 3D location calculator 350 may transmit the calculated 3D pupil location coordinates to the viewing window controller 120.

According to an embodiment of the present invention, the pupil tracker 110 may detect a pupil from a color image based on a location of an eye detected from a depth image to prevent an error occurring when the pupil is detected from a low-resolution depth image and accurately determine a location of the pupil. Also, the pupil tracker 110 may search for the pupil in a region corresponding to the location of the eye detected from the depth image to reduce a range in which the searching for the pupil is performed in the color image and minimize an amount of calculation required for the searching for the pupil.

FIG. 4 is a diagram illustrating the pupil tracker 110 according to another embodiment of the present invention.

FIG. 4 illustrates an example of the pupil tracker 110 that may determine a location of an eye in a depth image and a color image, and determine a location of a pupil by combining results of the determining of respective locations of the eye in the depth image and the color image.

Referring to FIG. 4, the pupil tracker 110 includes a camera calibration unit 410, a first eye location determiner 420, an eye location estimator 430, a second eye location determiner 440, a pupil location determiner 450, and a 3D location calculator 460.

The camera calibration unit 410 may perform stereo calibration to correct a distance between a left camera and a right camera of the stereo camera 102 using a general stereo calibration method. Also, the camera calibration unit 410 may perform the calibration between the depth camera 101 and the stereo camera 102. A detailed operation of the camera calibration unit 410 may be identical to an operation of the camera calibration unit 310 described with reference to FIG. 3 and thus, repeated descriptions will be omitted for conciseness.

The first eye location determiner 420 may determine the location of the eye of the user in the depth image captured by the depth camera 101. The first eye location determiner 420 may determine the location of the eye of the user in the depth image using a general face and eye recognition algorithm, and extract coordinates of the determined location of the eye. For example, the first eye location determiner 420 may estimate a face of the user using a Haar feature based face recognition or Local Binary Pattern (LBP) based face recognition or an AAM method.

The eye location estimator 430 may estimate a location of the eye in the color image based on the location of the eye determined by the eye location determiner 420. Here, the eye location estimator 430 may estimate the location of the eye corresponding to a location of the eye determined by the eye location determiner 420 in the color image using mapping information calculated by the camera calibration unit 410. For example, the eye location estimator 430 may be a mapping module to extract coordinates of the eye in the color image captured by the stereo camera 102 using the mapping information and the coordinates of the eye extracted from the depth image.

The second eye location determiner 440 may determine a location of the eye of the user in the color image captured by the stereo camera 102. The second eye location determiner 440 may determine the location of the eye of the user in the color image using a general face and eye recognition algorithm, and extract coordinates of the determined location of the eye. For example, the second eye location determiner 440 may determine the location of the eye of the user in the color image using the face and eye recognition algorithm identical to that used by the first eye location determiner 420. Alternatively, the second eye location determiner 440 may determine the location of the eye of the user in the color image using a face and eye recognition algorithm different from that used by the first eye location determiner 420.

The pupil location determiner 450 may set an eye region based on the location of the eye estimated by the eye location estimator 430 and the location of the eye determined by the second eye location determiner 440. The pupil location determiner 450 may determine the location of the pupil by searching for the location of the pupil in the eye region.

The pupil location determiner 450 may determine a validity of the location of the eye estimated by the eye location estimator 430 and the location of the eye determined by the second eye location determiner 440, and set the eye region based on a result of the determining. For example, when one of the location of the eye estimated by the eye location estimator 430 and the location of the eye determined by the second eye location determiner 440 is valid, the pupil location determiner 450 may set the valid location of the eye to be the eye region. When both of the location of the eye estimated by the eye location estimator 430 and the location of the eye determined by the second eye location determiner 440 are valid, the pupil location determiner 450 may set the eye region by combining the location of the eye estimated by the eye location estimator 430 and the location of the eye determined by the second eye location determiner 440. For example, the pupil location determiner 450 may set the eye region based on Equation 4.

X_{new}=α_{d}X_{d}+αₛXₛ [Equation 4]

In Equation 4, “X_{new}” denotes a location of the eye region. “X_{d}” denotes the location of the eye estimated by the eye location estimator 430, and “α_{d}” denotes a weighted value of the location of the eye estimated by the eye location estimator 430. Also, “Xₛ” denotes the location of the eye determined by the second eye location determiner 440, and “αₛ” denotes a weighted value of the location of the eye determined by the second eye location determiner 440.

Also, the pupil location determiner 450 may store a location of the pupil determined in a previous frame of the color image and the depth image. The pupil location determiner 450 may compare the location of the eye estimated by the eye location estimator 430 and the location of the eye determined by the second eye location determiner 440 to the location of the pupil determined in the previous frame, and set the eye region based on a result of the comparing. For example, the pupil location determiner 450 may set, as the location of the eye, a location closest to the stored location of the pupil from between the location of the eye estimated by the eye location estimator 430 and the location of the eye determined by the second eye location determiner 440.

The 3D location calculator 460 may calculate 3D pupil location coordinates based on a location of a left pupil and a location of a right pupil determined by the pupil location determiner 450. The 3D location calculator 460 may transmit the calculated 3D pupil location coordinates to the viewing window controller 120.

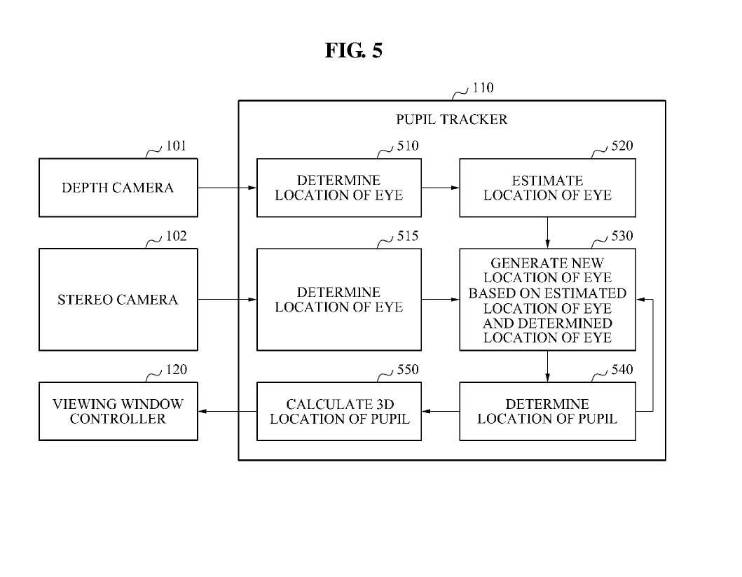

FIG. 5 is a diagram illustrating an operation of the pupil tracker 110 according to another embodiment of the present invention.

Referring to FIG. 5, in operation 510, the first eye location determiner 420 determines a location of an eye of a user in a depth image captured by the depth camera 101. The first eye location determiner 420 may determine the location of the eye of the user in the depth image using a general face and eye recognition algorithm, and extract coordinates of the determined location of the eye.

In operation 515, the second eye location determiner 440 determines a location of the eye of the user in a color image captured by the stereo camera 102. The second eye location determiner 440 may determine the location of the eye of the user in the color image using a general face and eye recognition algorithm, and extract coordinates of the determined location of the eye. Here, operations 510 and 515 may be performed concurrently or sequentially.

In operation 520, the eye location estimator 430 estimates a location of the eye in the color image based on the location of the eye determined in operation 510. The eye location estimator 430 may estimate coordinates corresponding to the location of the eye in the color image using mapping information.

In operation 530, the pupil location determiner 450 generates a new location of the eye based on the location of the eye estimated in operation 520 and the location of the eye determined in operation 515. Also, the pupil location determiner 450 may set the new location of the eye to be an eye region. For example, when a value of one of the location of the eye estimated by the eye location estimator 430 and the location of the eye determined by the second eye location determiner 440 is valid, the pupil location determiner 450 may generate the valid location of the eye as a new location of the eye. When both of the location of the eye estimated by the eye location estimator 430 and the location of the eye determined by the second eye location determiner 440 are valid, the pupil location determiner 450 may generate a new location of the eye by combining the location of the eye estimated by the eye location estimator 430 and the location of the eye determined by the second eye location determiner 440.

In operation 540, the pupil location determiner 450 determines the location of the pupil by searching for the location of the pupil in the eye region set in operation 530. The pupil location determiner 450 may store the determined location of the eye, and generate a new location of the eye based on the stored location of the pupil when operation 530 is performed in a next frame. For example, the pupil location determiner 450 may set, as the location of the eye, a location closest to the stored location of the pupil from between the location of the eye estimated by the eye location estimator 430 and the location of the eye determined by the second eye location determiner 440.

In operation 550, the 3D location calculator 460 calculates 3D pupil location coordinates based on a location of a left pupil and a location of a right pupil determined in operation 540. The 3D location calculator 460 may transmit the calculated 3D pupil location coordinates to the viewing window controller 120.

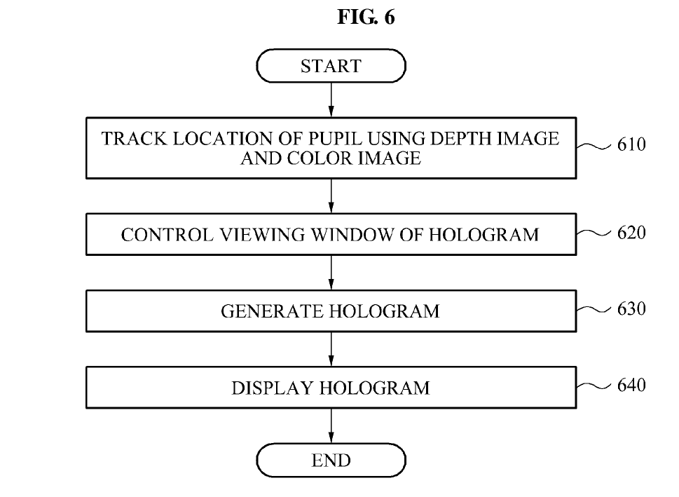

FIG. 6 is a flowchart illustrating a hologram displaying method according to an embodiment of the present invention.

Referring to FIG. 6, in operation 610, the pupil tracker 110 tracks a location of a pupil of a user using a depth image generated by capturing an image of the user by the depth camera 101 and a color image generated by capturing an image of the user by the stereo camera 102.

In operation 620, the viewing window controller 120 controls a viewing window of a hologram based on the location of the pupil of the user tracked in operation 610. The viewing window controller 120 may control the viewing window of the hologram by controlling positions of a light source and an SLM used to output the hologram.

In operation 630, the hologram generator 130 generates a hologram optimized for a visual field of the user based on the viewing window controlled in operation 620.

In operation 640, the hologram display 140 outputs the hologram generated in operation 630 to a space and displays the hologram.

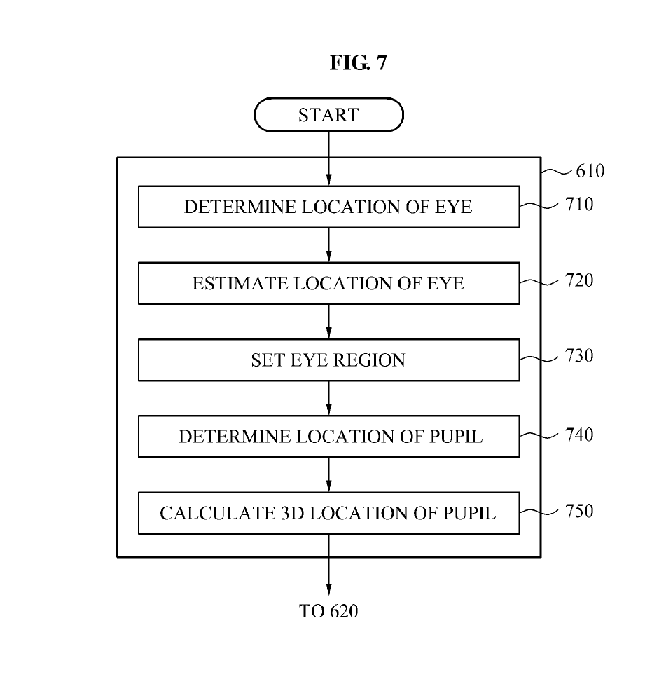

FIG. 7 is a flowchart illustrating a pupil tracking method according to an embodiment of the present invention. Operations 710 through 750 may be included in operation 610 described with reference to FIG. 6.

FIG. 7 illustrates a process of tracking a location of a pupil by the pupil tracker 110 illustrated in FIG. 3.

Referring to FIG. 7, in operation 710, the eye location determiner 320 determines a location of an eye of a user in a depth image captured by the depth camera 101. The eye location determiner 320 may determine the location of the eye of the user in the depth image using a general face and eye recognition algorithm and extract coordinates of the determined location of the eye.

In operation 720, the eye location estimator 330 estimates a location of the eye in a color image based on the location of the eye determined in operation 710. The eye location estimator 330 may estimate a location corresponding to the location of the eye determined by the eye location determiner 320 in the color image using mapping information calculated by the camera calibration unit 310.

In operation 730, the pupil location determiner 340 sets the location of the eye estimated in operation 720 to be an eye region.

In operation 740, the pupil location determiner 340 determines the location of the pupil by searching for the location of the pupil in the eye region set in operation 720.

In operation 750, the 3D location calculator 350 calculates 3D pupil location coordinates based on a location of a left pupil and a location of a right pupil determined in operation 740, and transmits the calculated 3D pupil location coordinates to the viewing window controller 120.

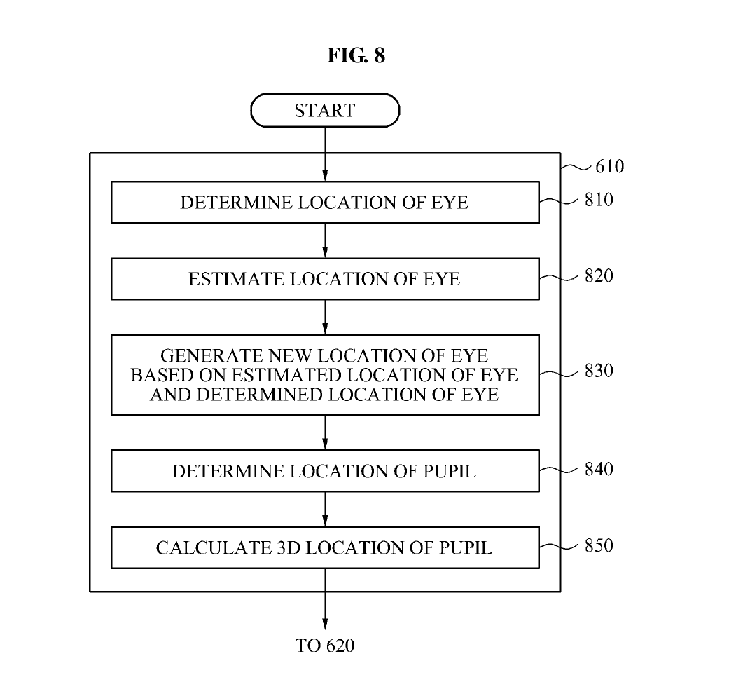

FIG. 8 is a flowchart illustrating a pupil tracking method according to another embodiment of the present invention. Operations 810 through 850 may be included in operation 610 described with reference to FIG. 6.

FIG. 8 illustrates a process of tracking a location of a pupil by the pupil tracker 110 illustrated in FIG. 4.

Referring to FIG. 8, in operation 810, the first eye location determiner 420 determines a location of an eye of a user in a depth image captured by the depth camera 101. Also, the second eye location determiner 440 determines a location of the eye of the user in a color image captured by the stereo camera 102.

In operation 820, the eye location estimator 430 estimates a location of the eye in the color image based on the location of the eye determined by the first eye location determiner 420. Here, the eye location estimator 430 may estimate coordinates corresponding to the location of the eye in the color image using mapping information.

In operation 830, the pupil location determiner 450 generates a new location of the eye based on the location of the eye estimated in operation 820 and the location of the eye determined by the second eye location determiner 440. Also, the pupil location determiner 450 sets the new location of the eye to be an eye region. For example, when a value of one of the location of the eye estimated by the eye location estimator 430 and the location of the eye determined by the second eye location determiner 440 is valid, the pupil location determiner 450 may generate the valid location of the eye as the new location of the eye. For another example, when both of the location of the eye estimated by the eye location estimator 430 and the location of the eye determined by the second eye location determiner 440 are valid, the pupil location determiner 450 may generate the new location of the eye by combining the location of the eye estimated by the eye location estimator 430 and the location of the eye determined by the second eye location determiner 440.

In operation 840, the pupil location determiner 450 determines the location of the pupil by searching for the location of the pupil in the eye region set in operation 830.

In operation 850, the 3D location calculator 460 calculates 3D pupil location coordinates based on a location of a left pupil and a location of a right pupil determined in operation 840, and transmits the calculated 3D location coordinates to the viewing window controller 120.

According to example embodiments of the present invention, an error in a pupil detecting process may be minimized and a calculation speed may increase by tracking a pupil of a user using a color image captured by a stereo camera and a depth image captured by a depth camera.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A hologram display apparatus, comprising:
a pupil tracker to track a location of a pupil of a user using a depth image and a color image generated by capturing an image of the user;
a viewing window controller to control a viewing window of a hologram based on the tracked location of the pupil of the user; and
a hologram generator to generate a hologram based on the controlled viewing window.

2. The apparatus of claim 1, wherein the pupil tracker comprises:
an eye location determiner to determine a location of an eye of the user in the depth image;
an eye location estimator to estimate a location of the eye in the color image based on the determined location of the eye; and
a pupil location determiner to determine the location of the pupil in the color image based on the estimated location of the eye.

3. The apparatus of claim 1, wherein the pupil tracker comprises:
a first eye location determiner to determine a location of an eye of the user in the depth image;
an eye location estimator to estimate a location of the eye in the color image based on the determined location of the eye;
a second eye location determiner to determine a location of the eye in the color image; and
a pupil location determiner to determine the location of the pupil in the color image based on the estimated location of the eye in the color image and the determined location of the eye in the color image.

4. The apparatus of claim 3, wherein the pupil location determiner determines a validity of the estimated location of the eye in the color image and the determined location of the eye in the color image, sets an eye region based on a result of the determining, and determines the location of the pupil by searching for the pupil in the eye region.

5. The apparatus of claim 3, wherein the pupil location determiner compares the estimated location of the eye in the color image and the determined location of the eye in the color image to a location of the pupil determined in a previous frame, sets an eye region based on a result of the comparing, and determines the location of the pupil by searching for the pupil in the eye region.

6. The apparatus of claim 2, further comprising:
a camera calibration unit to perform calibration between a stereo camera capturing the color image and a depth camera capturing the depth image.

7. The apparatus of claim 6, wherein the camera calibration unit calculates mapping information used to map three-dimensional (3D) coordinates of the depth image to two-dimensional (2D) coordinates of the color image based on an equation representing a projection relationship between the 3D coordinates of the depth image and the 2D coordinates of the color image.

8. A pupil tracking apparatus, comprising:
an eye location determiner to determine a location of an eye of a user in a depth image;
an eye location estimator to estimate a location of the eye in a color image based on the determined location of the eye; and
a pupil location determiner to determine a location of a pupil in the color image based on the estimated location of the eye.

9. A pupil tracking apparatus, comprising:
a first eye location determiner to determine a location of an eye of a user in a depth image;
an eye location estimator to estimate a location of the eye in a color image based on the determined location of the eye;
a second eye location determiner to determine a location of the eye in the color image; and
a pupil location determiner to determine a location of a pupil in the color image based on the estimated location of the eye in the color image and the determined location of the eye in the color image.

10. The pupil tracking apparatus of claim 9, wherein the pupil location determiner determines a validity of the estimated location of the eye in the color image and the determined location of the eye in the color image, sets an eye region based on a result of the determining, and determines the location of the pupil by searching for the pupil in the eye region.

11. The pupil tracking apparatus of claim 10, wherein, when one of the estimated location of the eye in the color image and the determined location of the eye in the color image is valid, the pupil location determiner sets the valid location to be the eye region.

12. The pupil tracking apparatus of claim 10, wherein, when both of the estimated location of the eye in the color image and the determined location of the eye in the color image are valid, the pupil location determiner sets the eye region by combining the estimated location of the eye in the color image and the determined location of the eye in the color image.

13. The pupil tracking apparatus of claim 9, wherein the pupil location determiner compares the estimated location of the eye in the color image and the determined location of the eye in the color image to a location of the pupil determined in a previous frame, sets an eye region based on a result of the comparing, and determines the location of the pupil by searching for the pupil in the eye region.

14. A hologram displaying method, comprising:
tracking a location of a pupil of a user using a depth image and a color image generated by capturing an image of the user;
controlling a viewing window of a hologram based on the tracked location of the pupil of the user; and
generating a hologram based on the controlled viewing window.

15. The method of claim 14, wherein the tracking of the location of the pupil comprises:
determining a location of an eye of the user in the depth image;
estimating a location of the eye in the color image based on the determined location of the eye; and
determining a location of the pupil in the color image based on the estimated location of the eye.

16. The method of claim 14, wherein the tracking of the location of the pupil comprises:
determining a location of an eye of the user in the depth image;
estimating a location of the eye in the color image based on the determined location of the eye;
determining a location of the eye in the color image; and
determining the location of the pupil in the color image based on the estimated location of the eye in the color image and the determined location of the eye in the color image.

17. The method of claim 16, wherein the determining of the location of the pupil comprises determining a validity of the estimated location of the eye in the color image and the determined location of the eye in the color image, setting an eye region based on a result of the determining, and determining the location of the pupil by searching for the pupil in the eye region.

18. The method of claim 16, wherein the determining of the location of the pupil comprises comparing the estimated location of the eye in the color image and the determined location of the eye in the color image to a location of the pupil determined in a previous frame, setting an eye region based on a result of the comparing, and determining the location of the pupil by searching for the pupil in the eye region.

19. A pupil tracking method, comprising:
determining a location of an eye of a user in a depth image;
estimating a location of the eye in a color image based on the determined location of the eye; and
determining a location of a pupil in the color image based on the estimated location of the eye.

20. A pupil tracking method, comprising:
determining a location of an eye of a user in a depth image;
estimating a location of the eye in a color image based on the determined location of the eye;
determining a location of the eye in the color image; and
determining a location of a pupil in the color image based on the estimated location of the eye in the color image and the determined location of the eye in the color image.
